(19) United States
(12) Patent Application Publication
(10) Pub. No.: US 2024/0107986 A1
(43) Pub. Date: Apr. 4, 2024

(54) FISH IDENTIFICATION DEVICE AND FISH IDENTIFICATION METHOD

(71) Applicant: Wistron Corp., New Taipei City (TW)

(72) Inventors: Zhe-Yu LIN, New Taipei City (TW); Chih-Yi CHIEN, New Taipei City (TW); Chen Wei YANG, New Taipei City (TW); Tsun-Hsien KUO, New Taipei City (TW)

(21) Appl. No.: 18/154,339

(22) Filed: Jan. 13, 2023

(30) Foreign Application Priority Data
Oct. 3, 2022 (TW) 111137460

(51) Int. Cl. A01K 61/95; A01K 61/10

(52) U.S. Cl. CPC A01K 61/95; A01K 61/10

(57) ABSTRACT

A fish identification method is provided. The fish identification method includes capturing an image through a processor, wherein the image includes a fish image. The fish identification method includes identifying a plurality of feature points of the fish image through a coordinate detection model and obtaining a plurality of sets of feature-point coordinates. Each of the plurality of sets of feature-point coordinates corresponds to each of the plurality of feature points. The fish identification method further includes calculating a body length or an overall length of the fish image according to the plurality of sets of feature-point coordinates of the image.

### CROSS REFERENCE TO RELATED APPLICATIONS

This application claims priority of Taiwan Patent Application No. 111137460, filed on Oct. 3, 2022, the entirety of which is incorporated by reference herein.

### BACKGROUND OF THE INVENTION

### Field of the Invention

The present disclosure relates to an identification device and, in particular, to a fish identification device and a fish identification method.

### Description of the Related Art

When researchers conduct a survey of streams and fish, they will net the fish from the stream one by one and put them on a measurement board for taking a photo, measurement, and specie recording, so as to understand the ecological development of the fish in that stream.

However, it is inconvenient to use pencil and paper for these recording activities during the survey because paper can get wet, and it is difficult to perform measurement. For netting fish, the fish have to be stunned by electric shock first before they are netted. Then, the fish are placed flat on a measurement board for measurement and recording. During this process, the fish may be injured or even killed. If the current of the electric shock is not high enough or the process takes too long, the fish will wake up and flop around, making it hard to perform the measurement. Therefore, the survey must be completed within a short period of time, which makes it impossible to accurately obtain the growth status of the fish.

There are many fish species in the world. For example, there are about 300 species in Taiwan. It will cost a lot of money to hire a professional who is proficient in the identification by sight of 300 species of fish to visit streams for the survey.

Therefore, how to build a device and method that can identify the species of fish and calculate the length of the fish is one of the problems that need to be solved in this field.

### BRIEF SUMMARY OF THE INVENTION

In accordance with one feature of an embodiment in the present invention, the present disclosure provides a fish identification device. The fish identification device comprises a storage device and a processor. The processor accesses a coordinate detection model stored in the storage device to perform the coordinate detection model. The processor captures an image, and the image comprises a fish image. The processor identifies a plurality of feature points of the fish image through the coordinate detection model and obtains a plurality of sets of feature-point coordinates. Each plurality of sets of feature-point coordinates corresponds to each of the plurality of feature points. The processor calculates a body length or an overall length of the fish image according to the plurality of sets of feature-point coordinates of the image.

In accordance with one feature of an embodiment in the present invention, the present disclosure provides a fish identification method. The fish identification method comprises capturing an image through a processor, wherein the image comprises a fish image. The fish identification method comprises identifying a plurality of feature points of the fish image through a coordinate detection model and obtaining a plurality of sets of feature-point coordinates. Each of the plurality of sets of feature-point coordinates corresponds to each of the plurality of feature points. The fish identification method further comprises calculating a body length or an overall length of the fish image according to the plurality of sets of feature-point coordinates of the image.

The fish identification device and fish identification method described in the present disclosure can reduce the dimensionality (or reduce the resolution) of high-resolution images, so as to reduce the amount of computation required and improve the processing speed of the fish identification device. In addition, the coordinate detection model can detect the respective sets of feature-point coordinates corresponding to the feature points, and the processor can more accurately calculate the body length or the overall length of the fish image according to the sets of feature-point coordinates and a scale. Thus, the fish identification device and fish identification method described in the present disclosure greatly improve the accuracy of the measurement of the fish. Moreover, the image classification model can also identify the species of fish, and the processor can determine the number of the fish, the image, the shooting time, the classification result, the body length, the overall length, whether the fish is an invasive species, whether the fish is a protected species, whether the fish is an endemic species, thereby achieving a more efficient increase in the computation speed and obtaining more complete identification data.

### BRIEF DESCRIPTION OF THE DRAWINGS

In order to describe the manner in which the above-recited and other advantages and features of the disclosure can be obtained, a more particular description of the principles briefly described above will be rendered by reference to specific examples thereof which are illustrated in the appended drawings. Understanding that these drawings depict only example aspects of the disclosure and are not therefore to be considered to be limiting of its scope, the principles herein are described and explained with additional specificity and detail through the use of the accompanying drawings in which:

FIG. 1A is a block diagram of a fish identification system in accordance with one embodiment of the present disclosure;

FIG. 1B is a block diagram of a first electrical system in accordance with one embodiment of the present disclosure;

FIG. 2 is a flowchart of a fish identification method in accordance with one embodiment of the present disclosure;

FIG. 3A is a schematic diagram showing a low-resolution fish image in accordance with one embodiment of the present disclosure;

FIG. 3B is a schematic diagram showing a fish image in accordance with one embodiment of the present disclosure;

FIG. 4 is a schematic diagram showing a coordinate detection model in accordance with one embodiment of the present disclosure;

FIG. 5 is a schematic diagram of obtaining an actual length based on a scale in accordance with one embodiment of the present disclosure;

FIG. 6 is a schematic diagram showing an image classification model in accordance with one embodiment of the present disclosure; and

FIG. 7 is a schematic diagram showing identification information in accordance with one embodiment of the present disclosure.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The present invention is described with respect to particular embodiments and with reference to certain drawings, but the invention is not limited thereto and is only limited by the claims. It will be further understood that the terms “comprises,” “comprising,” “includes” and/or “including,” in response to used herein, specify the presence of stated features, integers, steps, operations, elements, and/or components, but do not preclude the presence or addition of one or more other features, integers, steps, operations, elements, components, and/or groups thereof.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

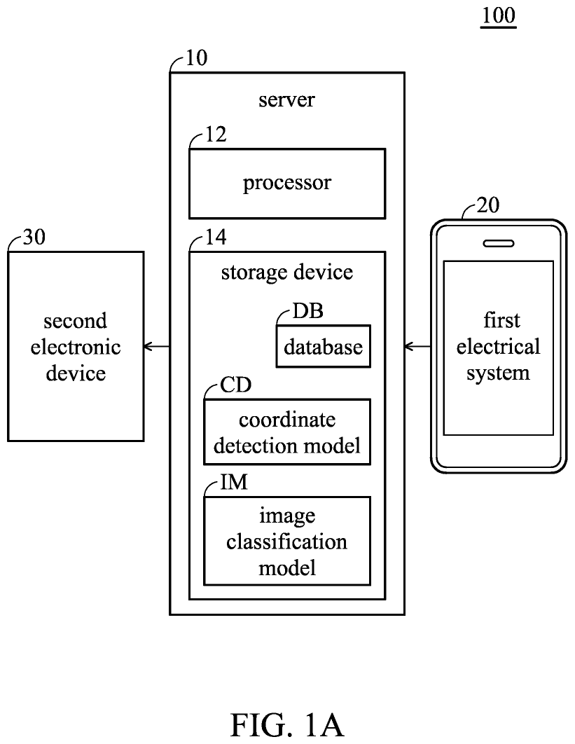

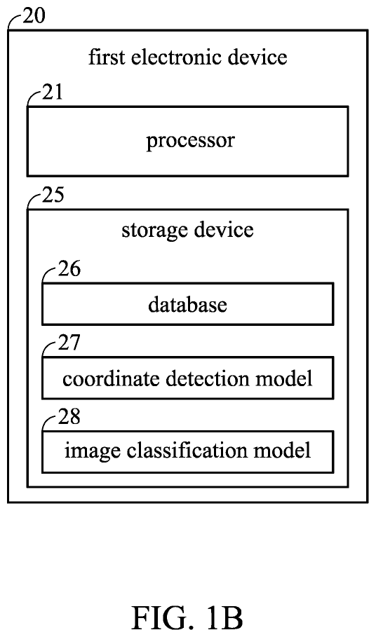

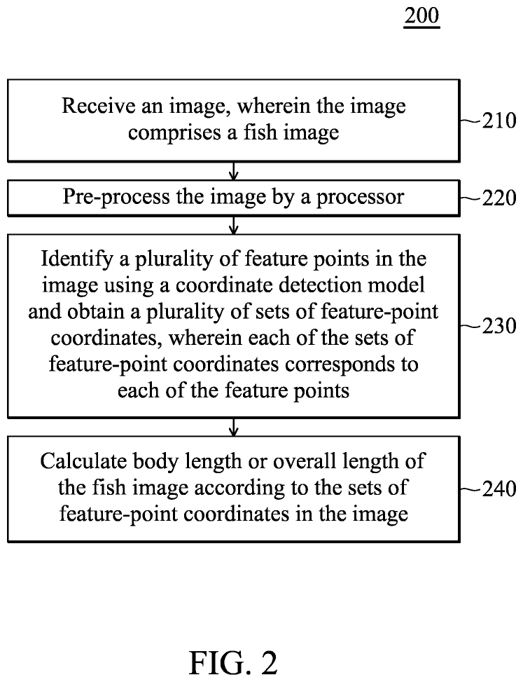

Please refer to FIGS. 1A, 1B, and 2. FIG. 1A is a block diagram of a fish identification system 100 in accordance with one embodiment of the present disclosure. FIG. 1B is a block diagram of a first electrical system 20 in accordance with one embodiment of the present disclosure. FIG. 2 is a flowchart of a fish identification method 200 in accordance with one embodiment of the present disclosure. In one embodiment, the fish identification method 200 can be implemented through the fish identification system 100 or the first electronic device 20.

As shown in FIG. 1A, the fish identification system 100 comprises the fish identification device. The fish identification device can be a server, a desktop computer, a notebook, or a virtual machine for architecture on a host operation system.

In one embodiment, the fish identification system 100 comprises the server 10, the first electronic device 20, and a second electronic device 30. The first electronic device 20 and the second electronic device 30 can be any electronic devices with a data transmission function, a computation function, and a storage function. For example, the first electronic device 20 can be a digital camera, a mobile phone, or a tablet, and the second electronic device 30 can be a mobile phone, a tablet, a server, a desktop computer, a notebook, or a virtual machine for architecture on a host operation system. In one embodiment, the second electronic device 30 can be the same electronic device as the first electronic device 20. In one embodiment, at least one of the second electronic device 30 and the first electronic device 20 further comprises a displayer (not shown in the figures).

In one embodiment, the function of the server 10 can be implemented by hardware circuit, wafer, firmware, or software.

In one embodiment, the server 100 comprises a processor 12 and a storage device 14. In one embodiment, the server 10 further comprises a displayer (not shown in the figures).

In one embodiment, the processor 12 can be implemented through a microcontroller, a microprocessor, a digital signal processor (DSP), an application specific integrated circuit (ASIC), a graphics processing unit (GPU), a graphics coprocessor, or a logic circuit.

In one embodiment, the storage device 14 can be realized by read-only memory, flash memory, floppy disk, hard disk, optical disk, flash drive, tape, network accessible database, or storage medium with the same function that is known to others skilled in the art.

In one embodiment, the processor 12 is used to access the program stored in the storage device 14 to implement the fish identification method 200.

In one embodiment, the storage device 14 is used to store a database DB, a coordinate detection model CD, and an image classification model IM.

In one embodiment, the coordinate detection model CD can be implemented by a known convolution neural network (CNN) or another image identification neural network that can be used to identify feature points in images.

In one embodiment, the image classification model IM can be implemented by a known convolution neural network or another image classification neural network that can be used to classify images.

In one embodiment, if the length of an object (such as a fish) is to be measured from an image, the measurement should be performed after the position and range of the object are obtained. A common object detection is achieved by a deep learning method, for example, Yolo (You only look once) and a region-based convolutional neural network (R-CNN). However, applying this method to detect a more complex object, the obtained prediction frame is less likely to fit the object, resulting in a greater error in the detected length of the fish. When the body length and the overall length of the fish are determined directly by the prediction frame, there is a greater error between the determined lengths and the actual lengths. In addition, if the fish is not placed at an angle of 180 degrees, the frame selection range is larger and does not fit the fish.

In one embodiment, the functions of the database DB, the coordinate detection model CD, and the image classification model IM can be implemented by hardware (circuit/wafer), software, or firmware.

In one embodiment, as shown in FIG. 1B, the first electronic device 20 comprises a processor 21 and a storage device 25, and the storage device 25 comprises a database 26, a coordinate detection model 27, and an image classification model 28. The coordinate detection model 27 and the image classification model 28 can be implemented by hardware, software, or firmware.

Considering that there is no internet connection when the user in the forest, the function of the server 10 can be implemented on the first electronic device 20 (for example, a mobile phone). The processor 21 in FIG. 1B is the same as the processor 12 in FIG. 1A, and the storage device 25 in FIG. 1B is the same as the storage device 14 in FIG. 1B.

In an embodiment, the respective functions of the coordinate detection model CD and the image classification model IM can be implemented by software or firmware that is stored in the storage device 14. The server 10 accesses the coordinate detection model CD and the image classification model IM stored in the storage device 14 through the processor 12, thereby achieving the function of the server 10.

The fish identification method 200 is described in the following paragraphs with reference to FIG. 2.

In Step 210, an image is received, wherein the image comprises a fish image.

In one embodiment, the image can be obtained through a camera module or a camera lens of the first electronic device 20 (for example, a mobile phone). In another embodiment, the image can also be obtained by accessing a connected device through a transmission circuit or a transmission interface or obtained from an image database. In one embodiment, the server 10 receives the image from the first electronic device 20.

In Step 220, the image is pre-processed by the processor 12.

In one embodiment, the image resolution is reduced by the processor 12. Since an excessively high resolution may cause a significant increase in the amount of computation when the model is trained, the image resolution can be reduced as much as possible without affecting the accuracy of the model training so as to reduce the amount of computation of the next models. For example, the resolution of 4000*3000 pixels is reduced to 540*405. In one embodiment, if the amount of the computation of the processor 12 or the processor 21 is sufficient, Step 220 may be omitted. In one embodiment, the processor 12 may selectively reduce the resolution in other steps. For example, the processor 12 reduces the resolution in order to reduce the amount of the computation of the subsequent coordinate detection model and the image classification model.

In one embodiment, the processor 12 performs the pre-processing operation on the fish image, and the pre-processing operation comprises reducing the resolution of the image.

In one embodiment, the pre-processing operation of the processor 12 further comprises cleaning and deleting inappropriate images from the fish image from the first electronic device 20, such as a blurred image, an image including multiple fish, and an images shot from a longer distance. At this stage, the operator can mark the key positions of the fish (such as feature points) and input the information of the fish (such as the species of the fish shown in the image). Moreover, the operator rotates the images to the same direction (for example, horizontal) and adjusts them to the same resolution to train the coordinate detection model CD and the image classification model IM, until the respective learning curves of the coordinate detection model CD and the image classification model IM tend to be stable, which means that the coordinate detection model CD and the image classification model IM have been trained and can be applied in the following stages.

In Step 230, a plurality of feature points in the image are identified through the coordinate detection model CD, and the sets of feature-point coordinates are obtained, wherein each of the sets of feature-point coordinates corresponds to each of the feature points.

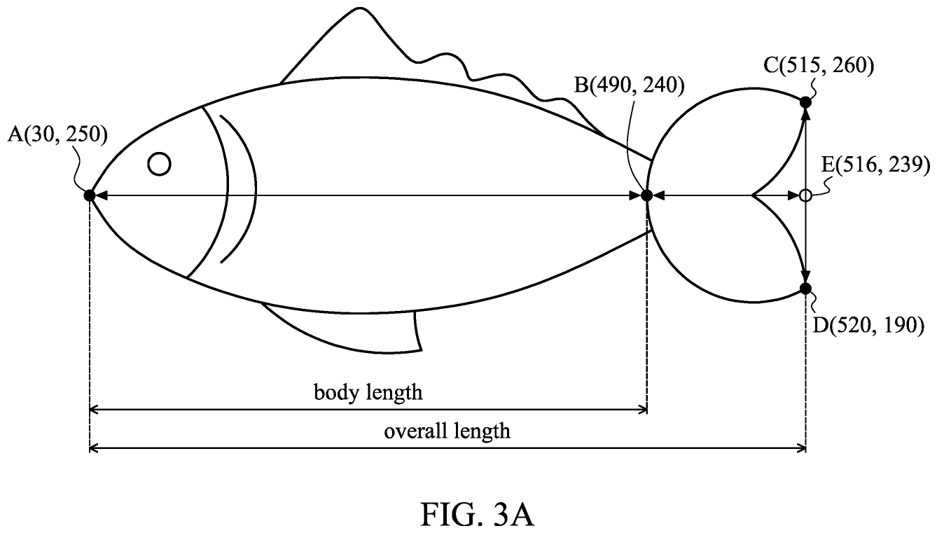

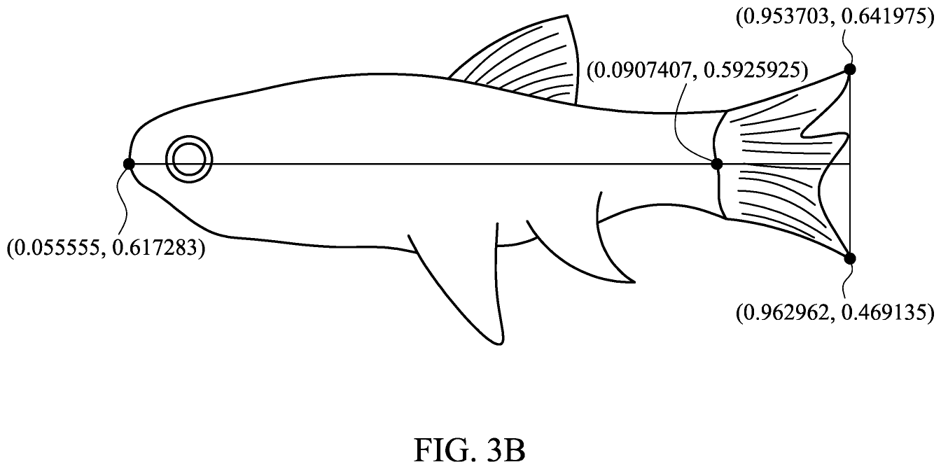

In one embodiment, please referring to FIG. 3A, FIG. 3A is a schematic diagram showing a low-resolution fish image in accordance with one embodiment of the present disclosure. The feature points in the fish image comprise a head, a body end, a tail up end, and a tail down end of the fish. For example, when the processor 12 inputs the image to the coordinate detection model CD, the coordinate detection model CD outputs these feature points and their sets of feature-point coordinates, which are: the set of coordinates A (30, 250) of the head of the fish, the set of coordinates B (490, 240) of the body end of the fish, the set of coordinates C (515, 260) of the tail up end of the fish, and the set of coordinates D (520, 190) of the tail down end of the fish.

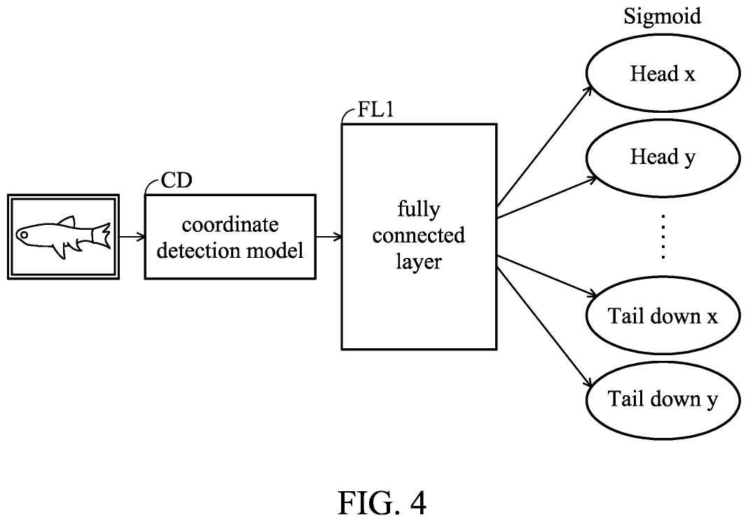

Please refer to FIG. 4, FIG. 4 is a schematic diagram showing a coordinate detection model CD in accordance with one embodiment of the present disclosure. In FIG. 4, the processor 12 inputs the image into the coordinate detection model CD, and the neural network of the coordinate detection model CD processes the image and inputs the obtained data to a fully connected layer FL1 in the final stage (in one embodiment, the coordinate detection model CD comprises the fully connected layer FL1; for clearer description, the fully connected layer FL1 is shown separately). The fully connected layer FL1 outputs “Head x” (representing the x value of the set of coordinates of the head of the fish), “Head y” (representing the y value of the sets of the coordinates of the head of the fish), . . . , “Tail down x” (representing the x value of the sets of coordinates of the tail down end of the fish), “Tail down y” (representing the y value of the sets of coordinates of the tail down end of the fish) and other coordinate values through a Sigmoid operation. In the example, there are 8 output values, so 4 sets of coordinates in the example can be derived.

In one embodiment, for extracting the features of the image, the first half of the coordinate detection model CD is, for example, a convolutional neural network (CNN) model that has a greater effect for image recognition. Common CNN models are, for example, ResNet, DenseNet, etc. The present disclosure is not limited to these specific models.

For example, please refer to FIG. 3B, FIG. 3B is a schematic diagram showing a fish image in accordance with one embodiment of the present disclosure. As shown in FIG. 3B, the sets of feature-point coordinates output by the coordinate detection model CD are all between 0 and 1, and the positions of the feature points in FIG. 3B correspond to the positions of the feature points in FIG. 3A respectively. The set of intersection coordinates E (516, 239) in FIG. 3A is obtained by calculation, which is described in detail below.

In FIG. 3B, the processor 12 multiplies each coordinate value by the resolution of the image (for example, 540*405). That is, each x value is multiplied by 540, and each y value is multiplied by 405. Thus, the coordinate values whose unit is pixel can be obtained: for example, the set of coordinates A (30,250) of the head of the fish, the set of coordinates B (490, 240) of the body end of the fish, the set of coordinates C (515, 260) of the tail up end of the fish, and the set of coordinates D (520, 190) of the tail down end of the fish, as shown in FIG. 3A.

In Step 240, the processor 12 calculates the body length or the overall length of the fish image according to the sets of feature-point coordinates in the image.

In one embodiment, the processor 12 calculates the body length or the overall length of the fish image according to the sets of feature-point coordinates in the image and a scale.

In one embodiment, these feature points comprise a head, a body end, a tail up end, and a tail down end of the fish. The processor 12 takes the set of coordinates A (30,250) of the head of the fish and the set of coordinates B (490,240) of the body end of the fish into an equation y=ax+b. The simultaneous equations

$$\{ \begin{matrix}250 = 30 a + b \\ 240 = 490 a + b\end{matrix}$$

are solved to obtain a first linear function. y=−0.021739x+250.65217. The processor 12 takes the set of coordinates C (515,260) of the tail up end of the fish and the set of coordinates D (520,190) of the tail down end of the fish into the equation y=ax+b. The simultaneous equations

$$\{ \begin{matrix}260 = 151 a + b \\ 190 = 520 a + b\end{matrix}$$

are solved to obtain a second linear function for the end of the tail of the fish. y=−14x+7470. According to the first linear function and the second linear function, the simultaneous equations

$$\{ \begin{matrix}20.65217 = 0.021739 x + y \\ 7470 = 14 x + y\end{matrix}$$

are solved to obtain a set of intersection coordinates E (516,239). The Euclidean distance between the set of coordinates A (30,250) of the head of the fish and the set of intersection coordinates E (516,239) is calculated to obtain an overall-length pixel (it is 486.1244). In the embodiment, the end of the tail of the fish indicates a line connecting the tail up end of the fish and the tail down end of the fish.

In one embodiment, the processor 12 calculates the overall length according to the actual length (2.6 cm) of the scale (for example, a coin) and the overall length-pixel (486.1244). The overall length is defined as the actual length from the head of the fish to the end of the tail of the fish.

In one embodiment, the processor 12 pre-processes the image to reduce the resolution of the image and detects the scale in the image through an object detection algorithm to obtain the pixel of the width or length of the scale and the actual width or the actual length of the scale.

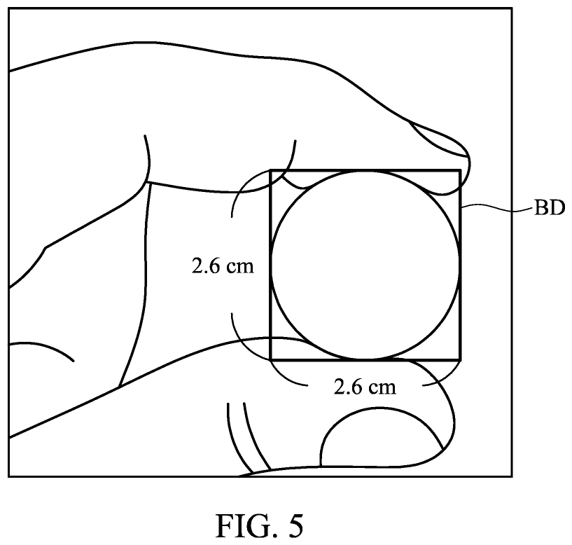

Please refer to FIG. 5, FIG. 5 is a schematic diagram of obtaining the actual length based on a scale in accordance with one embodiment of the present disclosure. In FIG. 5, the processor 12 selects the coin shown in the captured image through the object detection algorithm. The scale can be, for example, a coin, a credit card, a bank note, a pen, a wallet, a charm, a key, a finger, a blade, a buoy, a ruler, and the size or object features of these scales can be stored in the storage device 14 in advance. For the convenience of description, the following description will take a coin as an example. The actual length of the selected bounding box BD is 2.6 cm (the actual length can be stored in the storage device 14 or the storage device 25 in advance), and the pixel of the length of the bounding box is 2600. Thus, one pixel is equal to 0.001 cm by dividing 2.6 cm by 2600 (pixel). Finally, the actual overall length is obtained by multiplying the overall-length pixel 486.1244 by 0.001.

In one embodiment, the scale is photographed together with the fish, so the fish and the scale are shown in the image. In the above process, the processor 12 uses the scale in the image to calculate the actual body length and the overall length of the fish shown in the image. In one embodiment, the processor 12 calculates the Euclidean distance between the set of coordinates A (30, 250) of the head of the fish and the set of coordinates B (490, 240) of the body end of the fish to obtain a body-length pixel.

In one implementation, the processor 12 calculates the body length according to the actual length of the scale (for example, 2.6 cm) and the body-length pixel. The body length is defined as the actual length from the head of the fish to the body end of the fish.

In one embodiment, the processor 12 inputs the image to the image classification model IM. The image classification model IM outputs a plurality of classification probabilities corresponding to the image, and the processor 12 selects the highest probability among the classification probabilities as a classification result.

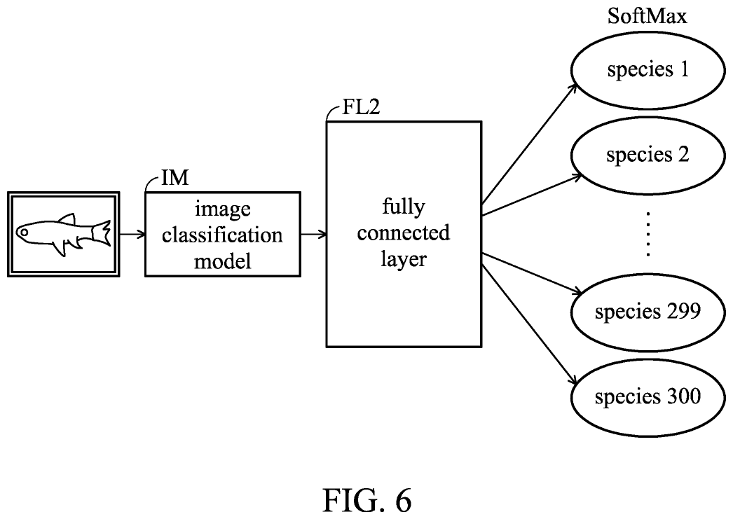

Please refer to FIG. 6, FIG. 6 is a schematic diagram showing an image classification model IM in accordance with one embodiment of the present disclosure. In FIG. 6, the processor 12 inputs the image into the image classification model IM, and the neural network of the image classification model IM processes the image and inputs the obtained data to a fully connected layer FL2 in the final stage (in one embodiment, the image classification model IM comprises the fully connected layer FL2; for clearer description, the fully connected layer FL2 is shown separately). The fully connected layer outputs a plurality of probability values (300 probability values in this example), which correspond to a category 1, a category 2, . . . , a category 299, and a category 300 respectively, through a Softmax operation. Of course, the number of categories provided is merely an example, and the present invention is not limited to this number of categories.

In one embodiment, the structure of the image classification model IM is similar to the coordinate detection model CD. For extracting the features of the image, the first half of the image classification model IM is, for example, a convolutional neural network (CNN) model. Common CNN models are, for example, ResNet, DenseNet, etc. The present disclosure is not limited to these specific models. The image classification model IM extracts the features in the image and then provides them to a neural network layer (for example, the fully connected layer FL2). The features are analyzed by the neural network layer FL2, and the probability values that the image belongs to the respective categories are finally determined by the SoftMax layer. The sum of the probability values of the categories is equal to 1. The processor 12 selects the category corresponding to the highest probability value as the classification result.

In one embodiment, the sum of the probability values of the categories is equal to 1.

In one embodiment, the processor defines the highest probability among the classification probabilities as a confidence level. For example, the probability value of the category 1 is 03906 that is the highest probability among the probability values, and the confidence level thereof is also 0.906. The corresponding category name (i.e., the classification result) is Hemimyzon taitungensis.

In one embodiment, the storage device 14 comprises a database DB, and the database DB stores a list of protected species and a list of endemic species.

In one embodiment, the processor 12 compares the classification result with the fish species recorded in the list of protected species to determine whether the classification result is a protected species. In response to the processor 12 determining that the classification result corresponds to the fish species recorded in the list of protected species, the processor 12 determines that the classification result is a protected species. In response to the processor 12 determining that the classification result does not correspond to the fish species recorded in the list of protected species, the processor 12 determines that the classification result is not a protected species.

In one embodiment, the processor 12 compares the classification result with the fish species recorded in the list of endemic species to determine whether the classification result is an endemic species. In response to the processor 12 determining that the classification result corresponds to the fish species recorded in the list of endemic species, the processor 12 determines that the classification result is an endemic species. In response to the processor 12 determining that the classification result does not correspond to the fish species recorded in the list of endemic species, the processor 12 determines that the classification result is not an endemic species (that is, an indigenous species).

In one embodiment, the storage device 14 comprises a database DB, and the database stores a list of fish origins. The processor 12 obtains a shooting location of the image and compares the shooting location with the origin recorded in the list of fish origins corresponding to the classification result to determine whether the fish is an invasive species. In response to the processor 12 determining that the shooting location is different from the origin in the list of fish origins corresponding to the classification result, the processor 12 determines that the classification result is an invasive species. In response to the processor 12 determining that the shooting location is the same as the origin in the list of fish origins corresponding to the classification result, the processor 12 determines that the classification result is not an invasive species. The first electronic device 20 comprises a global positioning system (GPS). When the first electronic device 20 captures the fish image, the first electronic device 20 adds the position information obtained through the global positioning system to the file of the fish image. The processor 12 defines the position information as a shooting location, so that the location where the fish appears can be obtained. In one embodiment, in response to the processor 12 taking the fish image through a camera lens, the processor 12 obtains the position information by a global positioning system and adds the position information to the file of the fish image. The processor 12 defines the position information as a shooting location.

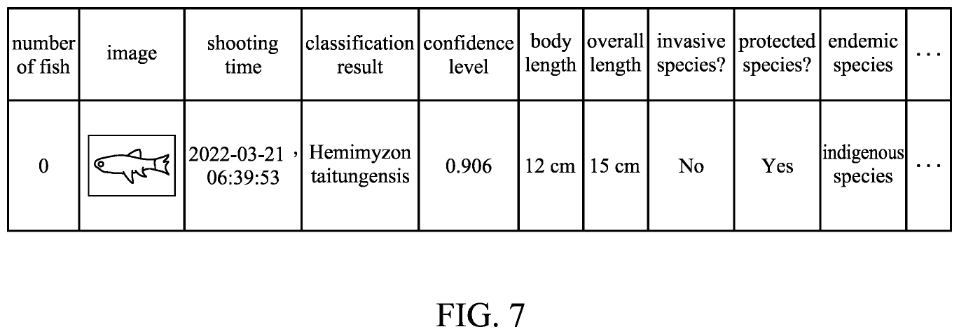

In one embodiment, please refer to FIG. 7, FIG. 7 is a schematic diagram showing identification information in accordance with one embodiment of the present disclosure. The processor 12 stores identification information into a database DB in the storage device 14, displays the identification information on a displayer, and/or transmits the identification information to the second electronic device 30 or the first electronic device 20.

In one embodiment, the identification information comprises a number (for example, 0) of the fish, the image, the shooting time (for example, 2022-03-21, 06:39:53), the classification result (for example, Hemimyzon taitungensis), the body length (for example, 12 cm), the overall length (for example, 15 cm), the result indicating whether the fish is an invasive species (for example, “no”), the result indicating whether the fish is a protected species (for example, “yes”), and the result indicating whether the fish is an endemic species (for example, “no”; that is, the fish is an indigenous species).

The fish identification device and fish identification method described in the present disclosure can reduce the dimensionality (or reduce the resolution) of high-resolution images, so as to reduce the amount of computation and improve the processing speed of the fish identification device. In addition, the coordinate detection model can detect the sets of feature-point coordinates respectively corresponding to the feature points, and the processor can more accurately calculate the body length or the overall length of the image fish according to the sets of feature-point coordinates and a scale. Thus, the fish identification device and fish identification method described in the present disclosure greatly improve the accuracy of the measurement of the fish. Moreover, the image classification model can also identify the species of fish, and the processor can determine the number of the fish, the image, the shooting time, the classification result, the body length, the overall length, whether the fish is an invasive species, whether the fish is a protected species, whether the fish is an endemic species, thereby achieving a more efficient increase in the computation speed and obtaining more complete identification data.

The methods of the present invention, or specific versions or portions thereof, may exist in the form of code. The code may be contained in physical media, such as floppy disks, optical discs, hard disks, or any other machine-readable (such as computer-readable) storage media, or not limited to external forms of computer program products. When the code is loaded and executed by a machine, such as a computer, the machine becomes a device for participating in the present invention. The code may also be transmitted through some transmission medium, such as wire or cable, optical fiber, or any type of transmission, wherein when the code is received, loaded, and executed by a machine, such as a computer, the machine becomes used to participate in the invented device. When implemented on a general-purpose processing unit, the code in conjunction with the processing unit provides a unique device that operates similarly to application-specific logic circuits.

Although the invention has been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such a feature may be combined with one or more other features of the other implementations as may be desired and advantageous for any given or particular application.

What is claimed is:

1. A fish identification device, comprising:
a storage device; and
a processor, wherein the processor accesses a coordinate detection model stored in the storage device to perform the coordinate detection model, wherein the processor:
captures an image, wherein the image comprises a fish image;
identifies a plurality of feature points of the fish image through the coordinate detection model and obtains a plurality of sets of feature-point coordinates, each of the plurality of sets of feature-point coordinates corresponds to each of the plurality of feature points; and
calculates a body length or an overall length of the fish image according to the plurality of sets of feature-point coordinates of the image.

2. The fish identification device of claim 1, wherein the plurality of feature points comprises a head, a body end, a tail up end, and a tail down end of a fish, and the processor takes a set of coordinates of the head and a set of coordinates of the body end into simultaneous equations to obtain a first linear function, takes a set of coordinates of the tail up end and a set of coordinates of the tail down end into the simultaneous equations to obtain a second linear function for an end of a tail of the fish, obtain a set of intersection coordinates by solving the simultaneous equations according to the first linear function and the second linear function, and calculates a Euclidean distance between the set of coordinates of the head and the set of intersection coordinates to obtain an overall-length pixel.

3. The fish identification device of claim 2, wherein the processor calculates the overall length according to an actual length of a scale and the overall-length pixel, and wherein the overall length is defined as an actual length from the head of the fish to the end of the tail of the fish, and the end of the tail of the fish indicates a line connecting the tail up end of the fish and the tail down end of the fish.

4. The fish identification device of claim 1, wherein the plurality of feature points comprises a head, a body end, a tail up end, and a tail down end of a fish, and the processor calculates a Euclidean distance between a set of coordinates of the head and a set of coordinates of the body end to obtain a body-length pixel.

5. The fish identification device of claim 4, wherein the processor calculates the body length according to an actual length of a scale and the body-length pixel, and wherein the body length is defined as an actual length from the head of the fish to the body end of the fish.

6. The fish identification device of claim 1, wherein the processor accesses an image classification model stored in the storage device, the processor inputs the image to the image classification model, the image classification model outputs a plurality of classification probabilities corresponding to the image, and the processor selects a classification corresponding to the highest probability among the plurality of classification probabilities as a classification result.

7. The fish identification device of claim 6, wherein:
the processor defines the highest probability among the plurality of classification probabilities as a confidence level corresponding to the classification result,
the storage device comprises a database, and the database stores a list of protected species and a list of endemic species,
the processor compares the classification result with the list of protected species to determine whether the classification result is a protected species,
in response to the processor determining that the classification result corresponds to a record in the list of protected species, the processor determining that the classification result is the protected species, and
the processor compares the classification result with the list of endemic species to determine whether the classification result is an endemic species,
in response to the processor determining that the classification result corresponds to a record in the list of endemic species, the processor determining that the classification result is the endemic species.

8. The fish identification device of claim 6, further comprising:
a global positioning system (GPS); and
a camera lens,
wherein in response to the processor capturing the fish image through the camera lens, the processor obtains position information through the global positioning system, adds the position information to a file of the fish image, and defines the position information as a shooting location,
wherein the storage device comprises a database, and the database stores a list of fish origins, and
wherein the processor obtains the shooting location and compares the shooting location with the list of fish origins corresponding to the classification result to determine whether the fish is an invasive species,
in response to the processor determining that the shooting location is different from an origin recorded in the list of fish origins corresponding to the classification result, the processor determining that the classification result is the invasive species.

9. The fish identification device of claim 6, wherein:
the processor stores identification information into a database in the storage device, displays the identification information on a displayer, or
transmits the identification information to an electronic device, and the identification information comprises a shooting time, the classification result, a confidence level corresponding to the classification result, the body length, the overall length, a result indicating whether the fish is an invasive species, a result indicating whether the fish is a protected species, and a result indicating whether the fish is an endemic species.

10. The fish identification device of claim 1, wherein the processor performs a pre-processing operation on the image to reduce resolution of the image and detects a scale in the image to obtain a pixel of a width or length of the scale and an actual width or an actual length of the scale.

11. A fish identification method, comprising:
capturing an image through a processor, wherein the image comprises a fish image;
identifying a plurality of feature points of the fish image through a coordinate detection model and obtaining a plurality of sets of feature-point coordinates, wherein each of the plurality of sets of feature-point coordinates corresponds to each of the plurality of feature points; and
calculating a body length or an overall length of the fish image according to the plurality of sets of feature-point coordinates of the image.

12. The fish identification method of claim 11, wherein the plurality of feature points comprises a head, a body end, a tail up end, and a tail down end of a fish, and the processor takes a set of coordinates of the head and a set of coordinates of the body end into simultaneous equations to obtain a first linear function, takes a set of coordinates of the tail up end and a set of coordinates of the tail down end into the simultaneous equations to obtain a second linear function for an end of a tail of the fish, obtains a set of intersection coordinates by solving the simultaneous equations according to the first linear function and the second linear function, and calculates a Euclidean distance between the set of coordinates of the head and the set of intersection coordinates to obtain an overall-length pixel.

13. The fish identification method of claim 12, further comprising:
calculating the overall length according to an actual length of a scale and the overall-length pixel through the processor, wherein the overall length is defined as an actual length from the head of the fish to the end of the tail of the fish, and the end of the tail of the fish indicates a line connecting the tail up end of the fish and the tail down end of the fish.

14. The fish identification method of claim 11, wherein the plurality of feature points comprises a head, a body end, a tail up end, and a tail down end of a fish, and the processor calculates a Euclidean distance between a set of coordinates of the head and a set of coordinates of the body end to obtain a body-length pixel.

15. The fish identification method of claim 14, further comprising:
calculating the body length according to an actual length of a scale and the body-length pixel through the processor, wherein the body length is defined as an actual length from the head of the fish to the body end of the fish.

16. The fish identification method of claim 11, further comprising:
inputting the image to an image classification model through the processor, wherein the image classification model outputs a plurality of classification probabilities corresponding to the image, and the processor selects a classification corresponding to the highest probability among the plurality of classification probabilities as a classification result.

17. The fish identification method of claim 16, further comprising:
defining the highest probability among the plurality of classification probabilities as a confidence level corresponding to the classification result through the processor,
wherein a storage device comprises a database, and the database stores a list of protected species and a list of endemic species,
wherein the processor compares the classification result with the list of protected species to determine whether the classification result is a protected species and determines that the classification result is the protected species in response to the processor determining that the classification result corresponds to a record in the list of protected species, and
wherein the processor compares the classification result with the list of endemic species to determine whether the classification result is an endemic species and determines that the classification result is the endemic species in response to the processor determining that the classification result corresponds to a record in the list of endemic species.

18. The fish identification method of claim 16, wherein:
in response to the processor capturing the fish image through a camera lens, the processor position information is obtained through the global positioning system, the position information is added to a file of the fish image, and defines the position information as a shooting location,
a storage device comprises a database, and the database stores a list of fish origins, and
the processor obtains the shooting location and compares the shooting location with the list of fish origins corresponding to the classification result to determine whether the fish is an invasive species and determines that the classification result is the invasive species in response to the processor determining that the shooting location is different from an origin recorded in the list of fish origins corresponding to the classification result.

19. The fish identification method of claim 16, further comprising:
storing identification information into a database in a storage device through the processor, displaying the identification information on a displayer, or transmitting the identification information to an electronic device,
wherein the identification information comprises a shooting time, the classification result, a confidence level corresponding to the classification result, the body length, the overall length, a result indicating whether the fish is an invasive species, a result indicating whether the fish is a protected species, and a result indicating whether the fish is an endemic species.

20. The fish identification method of claim 11, further comprising:
performing a pre-processing operation on the image through the processor to reduce resolution of the image; and
detecting a scale in the image to obtain a pixel of a width or length of the scale and an actual width or an actual length of the scale.
